(19) United States
(12) Patent Application Publication
(10) Pub. No.: US 2003/0119523 A1
(43) Pub. Date: Jun. 26, 2003

(54) Peer-based location determination

(76) Inventor: Willem Bulthuis, Portola Valley, CA (US)

Correspondence Address: Corporate Patent Counsel, U.S. Philips Corporation, 580 White Plains Road, Tarrytown, NY, 10591, US

(21) Appl. No.: 10/027,331

(22) Filed: Dec. 20, 2001

(51) Int. Cl. H04Q 7/20

(52) U.S. Cl. 455/456; 455/422

(57) ABSTRACT

Sensing devices are provided within a system, and these sensing devices are used to determine the location of emanating devices. Collocating the sensing devices with the emanating devices allows for a determination of a relative location of each emanating device, relative to each other emanating device, thereby obviating the need to obtain absolute locations of each emanating device. Given the location of each device, one or more aspects of the system are adjusted to improve system performance. In an audio system, the configuration and placement of loudspeakers can be adjusted to provide a proper acoustic balance. In a wireless system, the configuration and placement of base stations can be adjusted to prevent gaps in coverage. The relative location of a target emanation can also be determined, and the system can be adjusted to optimize the performance of the system relative to the location of the target emanation.

### BACKGROUND OF THE INVENTION

1. Field of the Invention

This invention relates to the field of electronic systems, and in particular to systems wherein the location of devices within the system affect the performance of the system.

2. Description of Related Art

Varieties of systems are dependent upon a physical, or geographical, relative distribution of devices. Advanced sound systems, for example, typically require a distribution of four or five speakers within a room to create a realistic reproduction of a recorded performance. Wireless networks require a distribution of base stations throughout a building, or other geographic coverage area. Other examples of distributed systems whose performance is dependent upon the distribution, or dispersion, of components within the system will be evident to one of ordinary skill in the art.

Generally, the location of each component of a distributed system is assumed to be known, or assumed to be specified. In a cellular telephone system, for example, the location of each base station/antenna tower is known, and the system parameters are set based on these known locations. In other systems, the proper location of distributed devices is assumed. That is, for example, in a home audio system, the system typically comes with instructions to the user regarding the proper placement of the speakers (right-rear, left-rear, right-front, left-front, center-front, etc.). The user arranges the speakers, and then attaches each speaker to the appropriate connection on the rear of the audio amplifier. Thereafter, it is assumed that the user has appropriately placed the speakers within the listening area, and has appropriately connected each speaker to the corresponding connection on the audio amplifier. In some systems, the user is provided an option of adjusting the gain for each speaker, or each pair of speakers, to appropriately “balance” the speakers within the particular environment. Determining whether the speakers are appropriately placed or balanced for optimal performance, however, is dependent upon the user's auditory skills, as well as the user's willingness to effect an optimization via a trial-and-error process. Optionally, a user can employ one or more monitoring devices to reduce the subjective nature of the analysis, but even with such tools, the user would be required to interpret the results from each monitoring device to effect the location adjustment or amplification balance.

In like manner, base stations of wireless local-area-networks (WLANS) are placed in available closets, common areas, etc. within an office, industrial, or home environment. In a typical embodiment, a ‘proper’ placement of each base station is based generally upon a model that assumes a uniform distribution of such base stations. Thereafter, the closest convenient location to each ‘proper’ location of each base station is selected for each base station. If and when a gap in coverage is reported, typically by a user who experiences the lack of coverage at the particular location, an additional base station is deployed in the region of the reported gap, or existing base stations are relocated to provide the coverage.

### BRIEF SUMMARY OF THE INVENTION

It is an object of this invention to provide a method and system that facilitates the placement of devices in a system throughout a locale to improve system performance. It is a further object of this invention to provide a method and system that facilitates the adjustment of a system based on the placement of devices in the system. It is a further object of this invention to provide a method and system for optimizing system performance, via components contained in peer-devices within the system.

These objects and others are achieved by providing sensing devices within a system, and using these sensing devices to determine the location of emanating devices. By collocating the sensing devices with the emanating devices, a relative location of each emanating device can be determined, obviating the need to obtain absolute locations of each emanating device. One or more aspects of the system are subsequently adjusted, based upon the location of the emanating devices, to improve system performance. In an audio system, the configuration and placement of loudspeakers can be adjusted to provide a proper acoustic balance. In a wireless system, the configuration and placement of base stations can be adjusted to prevent gaps in coverage. The relative location of a target emanation can also be determined, and the system can be adjusted to optimize the performance of the system relative to the location of the target emanation.

### BRIEF DESCRIPTION OF THE DRAWINGS

The invention is explained in further detail, and by way of example, with reference to the accompanying drawings wherein:

FIG. 1 illustrates an example block diagram of a system that includes devices that are distributed throughout an example environment.

FIG. 2 illustrates an example block diagram of a system controller for providing adjustments to a network of devices in a distributed system.

FIGS. 3A-3C illustrate an example location determination process for determining relative locations of distributed devices in a network.

Throughout the drawings, the same reference numerals indicate similar or corresponding features or functions.

### DETAILED DESCRIPTION OF THE INVENTION

The invention is presented herein using a paradigm of an audio system with distributed loudspeakers for emanating sounds, and microphones for detecting these sounds, for ease of presentation and understanding. It will be obvious to one of ordinary skill in the art, in view of this disclosure, that the principles of this invention are applicable to other systems with distributed devices, and are not dependent upon the particular transmission and reception technology used.

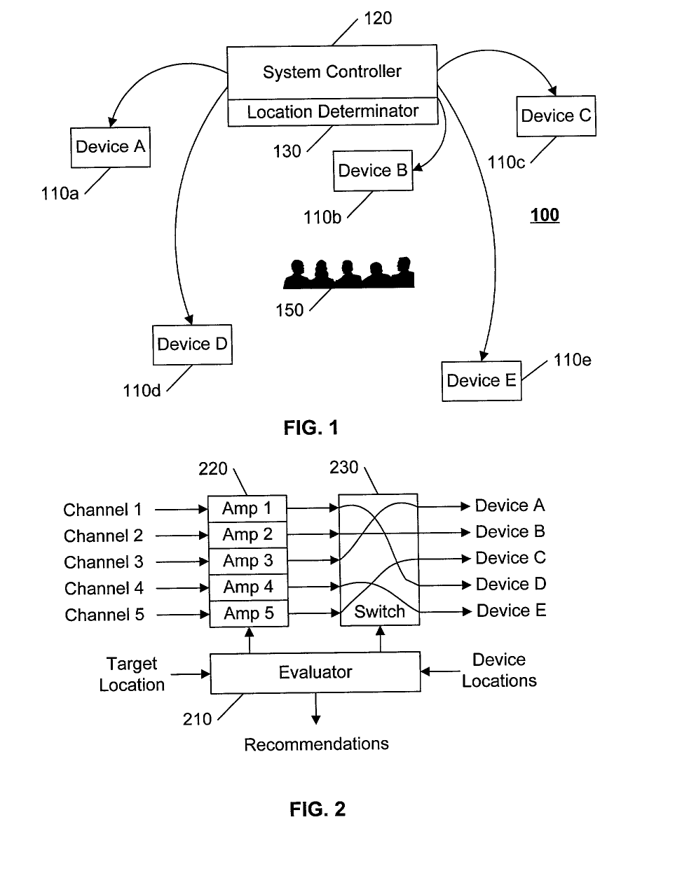

FIG. 1 illustrates an example system 100 having a plurality of devices 110a-e distributed about an environment. Using the paradigm of an audio system, for example, devices 110a, 110b, and 110c correspond to left-front, center-front, and right-front speakers, respectively, and devices 110d and 110e correspond to left-rear and right-rear speakers, respectively. A system controller 120 controls the signals that are provided to each of the devices 110a-e. For ease of reference, the identifier 110 is used hereinafter to refer to any or all of the devices 110a-e, when the context does not require an identification of a particular device 110a-e.

In accordance with this invention, the performance of the system 100 is dependent upon the distribution of the devices 110. A typical audio system, for example, includes instructions for speaker placement, to optimize the audio realism, or other audio effects, at a preferred location of a target audience 150. Generally, these instructions call for a uniform, or at least a right-left symmetric placement of the devices 110. In a typical environment, such as a living room of a home, however, aesthetic and decorative concerns typically determine the actual placement of the devices 110, and the actual placement may be suboptimal. Also in a typical environment, the shape of the room, the furnishings within the room, and other factors may affect the actual propagation of signals from the devices 110. Similarly, the propagation losses, delays, frequency characteristics, and so on, associated with the paths of signals communicated from the system controller 120 to each device 110 may differ, as well as the transform characteristics of each device 110.

Additionally, the installer of the devices 110 is often the homeowner, who may or may not be technically proficient. Although the proper connection of each device 110 may be verified by adjusting the left-right balance and assuring that the speakers on the left and right of the target location 150 are appropriately affected, and adjusting the front-rear balance and assuring that the speakers at the front and rear of the target location 150 are appropriately affected, such a verification may be overlooked, or avoided, by a non-technical user. A common fault of many users is an inattention to the phase (positive and negative) connection of each speaker, which can have a substantial effect on the audio quality of the composite sound produced by the plurality of speakers.

In accordance with this invention, the system 100 includes a location determinator 130 that is configured to determine the location of some or all of the devices 110. In a preferred embodiment, the location determinator determines the location of each device 110 based on actual emanations from the device, thereby determining the ‘virtual’ location of each device, in the context of the measured parameters associated with the emanations. For example, if the propagation delay to a given device is exceptionally long relative to the other devices, the audio effect of the delay will be similar to the device being located farther away from the other devices than it actually is. Additionally, as discussed further below, the measurement of parameters associated with the actual emanations allows for a determination of adjustments to the system to effect other than location-dependent optimizations.

Any of a variety of conventional techniques may be employed to determine the location of each device 110 based on emanations from each device. For example, the location determinator 130 may include an array of microphones at known locations, such as an array of microphones located on an enclosure of the location determinator 130. The location determinator 130 determines the location of a device 110 by having the system controller activate the device 110, and subsequently monitoring the receipt of the corresponding emanation from the device 110 at each of the distributed microphones. Because the emanation is controlled, and the same emanation is received at each of the distributed microphones, the location determinator 130 can determine either the direction of the device 110 from the location of the distributed microphones (based, for example, on a time difference between detections at different microphones), or a distance of the device 110 from each microphone (based, for example, on a time difference between origination and detection of the emanated signal at each microphone), or both. The intersection of direction vectors from alternative pairs of detectors identifies the location of the device 110, or, the intersection of a direction vector and a distance radius identifies the location of the device 110. When multiple determinations of the location of the device 110 are available, a least square error technique is conventionally employed to determine the likely location of the device 10, using techniques common in the art.

As is known in the art, however, location determination is highly dependent upon the separation between each detector used to determine location, because the conventional techniques for location determination rely upon a measure of differences between signals received by each detector. If the detectors are closely spaced, measuring a difference requires more sensitivity than measuring a difference between well-spaced detectors. For example, if the detectors are very closely spaced, the determined distance between an emanating device and the closely spaced detectors will be substantially equal, and the direction of the emanating device from each pair of closely spaced detectors will be difficult to determine.

In a preferred embodiment, the detectors are located coincident with the emanating devices. That is, because the emanating devices are typically spaced apart, placing a detector within each emanating device will provide the preferred distribution of well spaced detectors. In a conventional location determination system, the location of the detectors is assumed to be known. In this embodiment of the invention, it is recognized that knowledge of the relative location of each emanating device, relative to each other emanating device, is sufficient to facilitate an optimization of system performance.

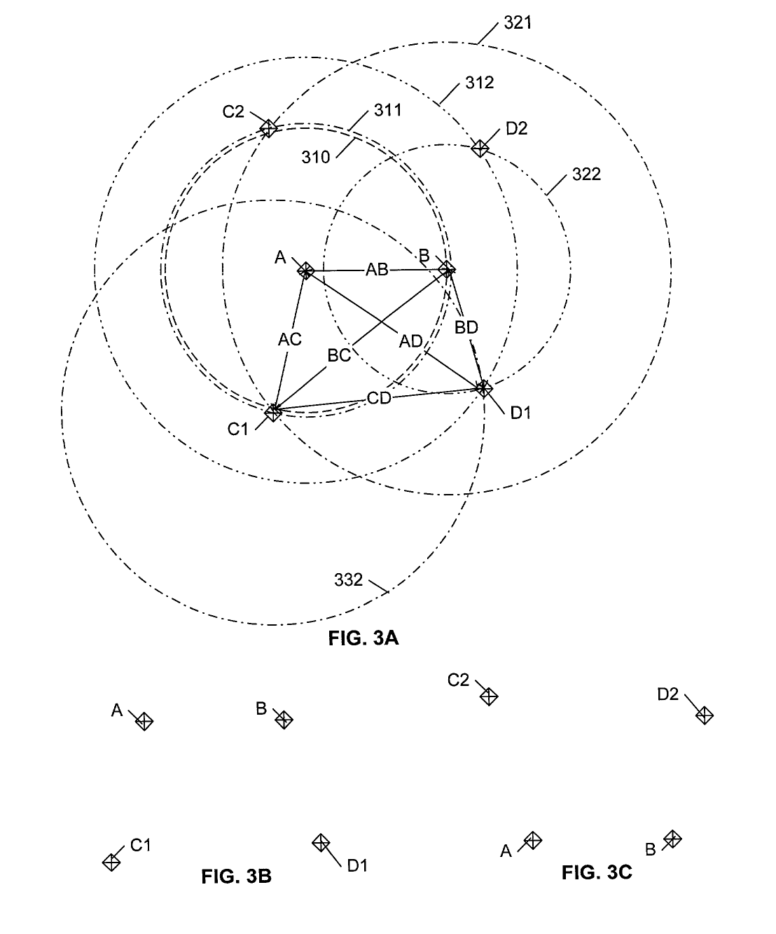

FIGS. 3A-3C illustrate an example location determination process for determining relative locations of distributed devices A-D in a network, with reference to the system 100 of FIG. 1. In this example, each of the devices A-D is configured to include a microphone for detecting emanations from the other devices. Initially, the system controller 120, under control of the location determinator 130, activates device A to emit a audible signal that is received at microphones that are located at each of the other devices B, C, and D. In a straightforward embodiment, the location determinator 130 is configured to compare the time-of-arrival of the audible signal at each of the devices B, C, D, to the time-of-transmission of the signal from device A. In a more sophisticated embodiment, the location determinator 130 is configured to detect a phase of the signal at each of the devices B, C, D, to compare to a phase of the signal from device A, for a finer resolution of the propagation time between device A and each of the other devices B-D. Based on the propagation time and the known propagation speed of a signal from device A in the given environment, the distance of each device B, C, D, from device A can be determined. Illustrated in FIG. 3A are concentric circles 310, 311, 312 centered on device A, each corresponding to a loci of points at the determined distance from device A. For convenience, the distances of the nodes B, C, and D from node A are illustrated in FIG. 3A as AB, AC, and AD, respectively.

In this example, the actual location of A is irrelevant; only device A's relationship to the location of the other devices B, C, and D, is relevant. In like manner, the actual location, or orientation, of device B relative to device A is irrelevant, and in FIG. 3A, device B is arbitrarily identified as being to the right of device A, at a distance AB from device A. That is, regardless of whether device B is north, south, east, or west of device A, or any orientation in between, the performance of the system is only a function of the distance between devices A and B, and thus any point on the loci 310 is suitable. Once device B is located relative to device A in FIG. 3A, the location of the other devices is no longer arbitrary, because the location of the other devices must be modeled with respect to the locations of both device A and device B. In most applications, the identification of “left” and “right” is rather arbitrary; that is, mirror images of a system are considered equivalent. In the event that the particular left/right configuration is significant, the user is provided the option of identifying a left or right device, or is provided the option of selecting between mirror images.

Under control of the location determinator 130, the system controller 120 activates device B, and notes the time and/or phase of the received signal at devices C and D. (The determinator 130 may also note the time and/or phase of the received signal at device B, to improve the accuracy of the determined distance AB.) Illustrated in FIG. 3A are concentric circles 321, 322 centered on device B, each corresponding to the loci of points at the determined distance BC, BD between device B and devices C and D, respectively.

Device C must be located at the intersection of loci 311 and 321, to conform to the determined distances AC, BC of device C from each of devices A and B. There are two such intersections, illustrated in FIG. 3A as locations C1 and C2.

Under control of the location determinator 130, the system controller 120 activates device C, and notes the time and/or phase of the received signal at device D, from which the distance CD is determined. (Optionally, detections at devices A and B may be noted, to improve the accuracy of the determined distances AC and BC.) Illustrated in FIG. 3A is a loci of points 332 at a radius CD from location C1. If device C is located at C1, then device D must be located at the intersection of loci 312, 322, and 332, which is illustrated in FIG. 3A as location D1. In like manner, location D2 identifies the feasible location of device D, if device C is located at location C2.

FIG. 3B illustrates the location of the devices A-D, if device C is located at C1. FIG. 3C illustrates the location of devices A-D, if device C is located at C2. As can be seen, FIGS. 3B and 3C are merely mirror images of each other. In a system whose performance is based on the dispersion of each device, relative to each other, it is obvious that the illustrated mirror locations in FIGS. 3B and 3C are equivalent.

Thus, as illustrated in FIGS. 3A-3C, because the emanators and detectors are co-located in accordance with this aspect of the invention, the relative locations of each device to each other device can be determined, without the conventional reliance upon knowledge of the actual location of the detection devices.

Once the locations of the devices 110 are determined, either relative to a known location or to each other, the system 100 of FIG. 1 can be adjusted to provide an improvement in the performance of the system 100. For the purposes of this invention, an adjustment includes adjustments that can be automatically made by the system, as well as adjustments that may require human intervention, such as the relocation of devices A-E, or the manual adjustment of control devices, such as volume controls or balance controls.

FIG. 2 illustrates an example block diagram of a system controller 120 for providing adjustments to a network of devices A-E in a distributed system, based on the locations of the devices A-E in the system, or, as presented further herein, based on the location of a target (150 in FIG. 1) in the system of distributed devices A-E.

An evaluator 210 is configured to determine the adjustments that can be made to improve the performance of the system. In a straightforward embodiment, the evaluator 210 provides recommendations to the user for relocating the devices A-E, rewiring the devices A-E, or adjusting the relative volume (balance) of the devices A-E, to achieve a preferred effect.

For example, a geographic center of the devices A-E can be determined, and the evaluator 210 can be configured to recommend an adjustment to the volume, or amplification, associated with one or more of the devices A-E to provide an appropriate perceived response from each of the devices A-E at this geographic center. For example, to achieve a sense of realism at a target location, the perceived amplitude from front speakers in a typical audio system may preferably be twice, or three times, the perceived amplitude from the rear speakers. If it is assumed that the target location is at the geographic center of the devices A-E, the evaluator 210 can provide recommendations for increasing or decreasing the relative amplitude of particular devices A-E to achieve this preferred balance between the front A-C and rear D-E devices. If the system controller 120 is configured to allow for automated adjustments of the amplitude of each channel of the system, as illustrated by the amplifiers 220 of FIG. 2, the evaluator 210 is configured to effect this recommended balance of the channels 1-5 corresponding to the devices A-E.

In like manner, the evaluator 210 can determine whether each of the devices A-E that are associated with each channel (left-front, right-front, center-front, right-rear, left-rear) are configured to provide the assumed orientation. If the determined locations of the devices A-E are relative to an absolute location or reference direction, the definition of left, right, front, and rear is straightforward, relative to the absolute location or direction. If the determined locations of the devices A-E are relative to each other, the evaluator 210 chooses two of the devices A-E and their associated channels as reference points, and then determines whether the determined locations of the other devices correspond to this reference. For example, using the example of FIGS. 3A-3C, if device A is connected to the left-front channel, and device B is connected to the right-front channel, then device C should be connected to the left-rear channel, and device D to the right-rear channel, corresponding to FIG. 3B. If devices C and D are erroneously connected to the right-rear and left-rear channels, respectively, the evaluator 210 provides a recommendation that the connections of these devices be interchanged, or, if the system controller 120 includes a configurable switch 230, the evaluator 210 effects this reconfiguration. In a preferred embodiment, when a misconfiguration based on an assumed reference is detected, the evaluator 210 evaluates each of the other possible reference options, and determines a reconfiguration that involves the fewest changes to the original configuration.

Also, a common fault in the connection of speakers in an audio system is inattention to the phase of the signals provided to each loudspeaker device A-E. As is known in the art, when two speakers are in-phase, and the same signal is provided to each, simultaneously, the sound is localized, as if it originates at a point between the two speakers. If the speakers are out-of-phase, the sound is diffused, without an identifiable origination point. In a preferred embodiment of this invention, the evaluator 210 is configured to determine the phase of each loudspeaker device AE, and, if an out-of-phase condition is detected, recommends or effects a reconfiguration of the devices to provide an in-phase relationship throughout.

As would be evident to one of ordinary skill in the art, the dynamic configuration of the components of the system may be effected using any of a variety of techniques. For example, to simplify wiring or communication channel requirements, some systems are configured to transmit a multiplexed signal along a common channel, and each device is configured to extract a select portion of the multiplexed signal. That is, the device to the left-front of the user is configured to extract the left-front channel of information from the multiplexed signal, the device to the right-front is configured to extract the right-front channel of information from the same multiplexed signal, and so on. In this embodiment, each device on the network is dynamically configured to extract a portion of the signal based on the determined location of each device relative to a target location. For ease of reference and understanding, the invention is discussed herein primarily in the context of independent physical links to each device in the system, although one of ordinary skill in the art will recognize that the principles of this invention are equally applicable to devices that employ a logical channel assignment, independent of the physical connection among the devices. In like manner, the switch 230 of FIG. 2 may be a logical switching device, rather than a matrix switch as illustrated.

As noted above, a target location may be assumed to be the geographic center, or some other point, relative to the determined locations of the devices A-E. In accordance with another aspect of this invention, the location determinator 130 of FIG. 1 is also configured to determine the target location 150, based on emanations from the target location 150. For example, the user may clap or provide some other audible signal that can be detected by the detectors associated with the location determinator 130. In a preferred embodiment of this invention, the evaluator 210 of FIG. 2 is configured to provide adjustments to the system based on the determined target location. As is known in the art, an adjustment of the phase and amplitude of speaker signals can effect a projection of sound to a given target location to achieve certain effects, such as to emulate the acoustics of a concert hall, a music studio, a sports stadium, and so on. These techniques can be applied to dynamically adjust the system to achieve a desired response from the system at the target location, based on the determination of the target location relative to the location of each of the devices A-E.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the system has been presented using the paradigm of an audio system. One of ordinary skill in the art will recognize that the principles of this invention can be applied to any system that relies on a distribution of devices to achieve a particular level or quality of performance. In a wireless system, such as an 802.11 wireless network, for example, the transmitter power or receiver sensitivity of each base station may be adjusted to provide optimal area coverage, or, suggestions can be provided for relocation particular base stations. In a conventional 802.11 wireless network, the base stations do not communicate with each other. In accordance with the principles of this invention, by configuring each base station to detect transmissions from the other base stations, the relative location of the base stations can be determined, and suggested or automated adjustments to these base stations can be provided. Additionally, because known signals can be transmitted from particular transmitters, the system can be configured to measure distortions and other factors, such as multi-path effects, attenuation characteristics, unintended resonances, and the like. If a particular phenomena or characteristic is detected, a warning can be provided to the user, suggesting a relocation or replacement of select components in the system. These and other system configuration and optimization features will be evident to one of ordinary skill in the art in view of this disclosure, and are included within the scope of the following claims.

I claim:

1. A system comprising:
a plurality of devices that are distributed within an environment, a location of one or more devices of the plurality of devices affecting a performance of the system,
a location determinator that is configured to determine the location of the one or more devices, based on feedback from the plurality of devices, and
an evaluator that is configured to determine an adjustment to the system to improve the performance of the system based on the location of the one or more devices.

2. The system of claim 1, wherein
at least two devices of the plurality of devices are configured to detect an emanation from a select device of the plurality of devices, and to communicate parameters associated with the detected emanation to the location determinator, and
the location determinator is configured to determine the location of the select device based on the parameters of the detected emanation.

3. The system of claim 2, wherein
the select device includes a loudspeaker, and
the at least two devices include microphones that are configured to detect an audio signal from the loudspeaker.

4. The system of claim 2, wherein
the select device includes a radio-frequency transmitter, and
the at least two devices include radio-frequency receivers that are configured to detect a radio-frequency signal from the transmitter.

5. The system of claim 2, wherein
the parameters associated with the detected emanation include at least one of:
a time of arrival of the detected emanation,
an amplitude of the detected emanation,
a phase of the detected emanation, and
a frequency characteristic of the detected emanation.

6. The system of claim 1, wherein
each device of at least a subset of the plurality of devices include:
an emanator that provides an emanated signal, and
a detector that detects emanated signals from other devices of the plurality of devices, and communicates one or more parameters associated with the emanated signals from the other devices to the location determinator, and
the location determinator is configured to determine the location of the other devices based on the parameters of the detected emanated signals.

7. The system of claim 6, wherein
each device of the subset of the plurality of devices includes a loudspeaker and a microphone for emanation and detection of audio signals.

8. The system of claim 7, wherein
the adjustment of the system includes at least one of:
a reconfiguration of channel assignment to one or more of the devices of the plurality of devices,
a recommended relocation of one or more of the devices of the plurality of devices, and
an adjustment of at least one of: a gain, a phase, a channel assignment, and a delay associated with one or more channels associated with the plurality of devices.

9. The system of claim 6, wherein
each device of the subset of the plurality of devices includes a transmitter and a receiver for emanation and detection of radio-frequency signals.

10. The system of claim 1, wherein
the adjustment of the system includes at least one of:
a reconfiguration of communication paths to one or more of the devices,
a relocation of one or more of the devices, and
an adjustment of at least one of: a gain parameter, a delay parameter, a channel assignment, and a phase parameter associated with one or more of the devices.

11. A controller for an audio system comprising:
a location determinator that is configured to determine a location of each loudspeaker of a plurality of loudspeakers, and
an evaluator that is configured to determine an adjustment to the audio system, based on the location of each loudspeaker.

12. The controller of claim 11, wherein
each of at least two loudspeakers of the plurality of loudspeakers include a microphone that is configured to detect emanations from the plurality of loudspeakers, to facilitate the determination of the location of each loudspeaker by the location determinator.

13. The controller of claim 11, wherein
each of at least two loudspeakers of the plurality of loudspeakers include a microphone that is configured to detect a sound from a target location in the vicinity of the plurality of loudspeakers, and
the location determinator is further configured to determine the target location based on parameters associated with the detection of the sound at the at least two loudspeakers, and
the adjustment to the audio system is further based on the target location.

14. The controller of claim 11, wherein
each loudspeaker of the plurality of loudspeakers corresponds to a channel of a plurality of channels of the audio system, and
the adjustment to the audio system includes at least one of:
a reconfiguration of correspondence between the plurality of loudspeakers and the plurality of channels,
an adjustment of at least one of: a gain, a phase, a delay, and a channel allocation associated with one or more of the plurality of channels, and
a recommended relocation of one or more of the plurality of loudspeakers.

15. The controller of claim 13, wherein
each of at least two loudspeakers of the plurality of loudspeakers include a microphone that is configured to detect emanations from the plurality of loudspeakers, to facilitate the determination of the location of each loudspeaker by the location determinator.

16. The controller of claim 11, wherein
the location determinator is further configured to effect one or more emanations from select loudspeakers, to facilitate the determination of the location of the select loudspeakers.

17. A controller for a wireless system comprising:
a location determinator that is configured to determine a location of each base station of a plurality of base stations, based on emanations from each base station, each base station being configured to provide communications to wireless devices in a vicinity of the base station, and
an evaluator that is configured to determine an adjustment to the wireless system, based on the location of each base station.

18. The controller of claim 17, wherein
each of at least two base stations of the plurality of base stations include a receiver that is configured to detect transmissions from the plurality of base stations, to facilitate the determination of the location of each base station by the location determinator.

19. The controller of claim 17, wherein
the adjustment to the wireless system includes at least one of:
an adjustment of at least one of: a gain, a phase, a delay, a frequency, and a channel allocation associated with one or more of the plurality of base stations, and
a recommended relocation of one or more of the plurality of base stations.

20. The controller of claim 19, wherein
each of at least two base stations of the plurality of base stations include a receiver that is configured to detect transmissions from the plurality of base stations, to facilitate the determination of the location of each base station by the location determinator.

21. A method of adjusting a system, comprising:
determining a location of each device of a plurality of devices, based on feedback from the plurality of devices, and
adjusting the system based on the location of each device.

22. The method of claim 21, further including
controlling each device of the plurality of devices to provide a controlled feedback from the plurality of devices.

23. The method of claim 21, further including
receiving the feedback from at least two devices of the plurality of devices, based on emanations from other devices of the plurality of devices.

24. The method of claim 21, wherein
determining the location of each device includes at least one of:
determining an arrival time of an emanation from each device at other devices of the plurality of devices,
determining a phase of an emanation from each device at other devices of the plurality of devices,
determining a frequency characteristic of an emanation from each device at other devices of the plurality of devices, and
determining an amplitude of an emanation from each device at other devices of the plurality of devices.

25. The method of claim 21, wherein
adjusting the system includes
adjusting at least one of: a gain, a phase, a delay, and a channel assignment associated with at least one device of the plurality of devices,
adjusting a mapping of the plurality of devices to a plurality of channels of the system, and
providing a recommended relocation of at least one device of the plurality of devices.
